(19) United States
(12) Patent Application Publication
(10) Pub. No.: US 2009/0294261 A1
(43) Pub. Date: Dec. 3, 2009

(54) Automotive acceleration alarm to inform the driver of when to limit excessive acceleration to decrease gasoline consumption

(76) Inventor: Peter J. Pociejewski, Des Plaines, IL (US)

Correspondence Address: Peter Pociejewski, 401 Simone Drive, Des Plaines, IL, 60016, US

(21) Appl. No.: 12/473,421

(22) Filed: May 28, 2009

Related U.S. Application Data
(60) Provisional application No. 61/056,450, filed on May 28, 2008.

(51) Int. Cl. H01H 35/14

(52) U.S. Cl. 200/61.52

(57) ABSTRACT

The present invention provides an alarm for the automobile driver when increased acceleration occurs. A roller ball tilt switch is rotated on a base level with the ground. The roller ball inside the tilt switch rolls back during acceleration. The L.E.D. light is illuminated due to the roller ball tilt switch completing a closed circuit.

### BACKGROUND OF INVENTION

Automobile drivers may not be aware of increasing acceleration which causes increasing gasoline consumption.

### BRIEF SUMMARY OF THE INVENTION

The present invention provides an audible and visual alarm the driver of an automobile when acceleration exceeds the desired limit. To save gasoline by limiting consumption, the driver becomes instantly aware of increasing acceleration due to the audible and visual acceleration alarm, and therefore reduces acceleration and gasoline consumption.

### BRIEF DESCRIPTION OF DRAWINGS

FIG. 1 is a side view of the Invention

FIG. 2 is a rear view of the Invention

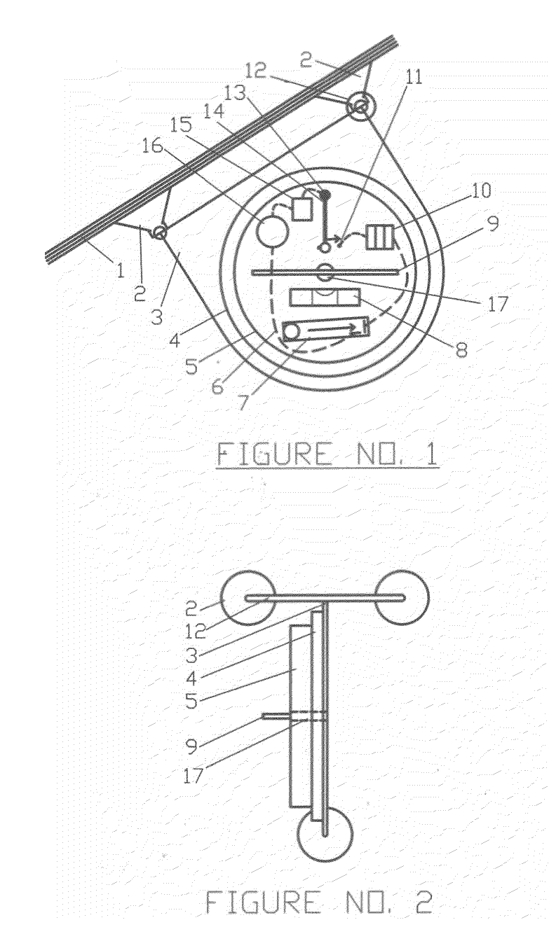

### DETAILED DESCRIPTION OF INVENTION DRAWINGS

The present invention is mounted to the inside of the automobile windshield 1 with suction cups 2 or removable adhesive tape. The stationary mounting plate 3 and stabilizer arm 12 help prevent racking and movement due to vehicle turning and movement. The rotating mounting plate 4 is rotated to a constant installation level. The rotating adjustment plate 5 contains the majority of components. The rotating adjustment plate 5 rotates about the axis 17 by turning the handle 9 to a degree, which is level with the vehicle at rest on level ground. The driver shall use the bubble level 8 and the vertical rod tilt switch 14 to attach the unit properly.

Once attached properly, the predetermined angle for the roller ball tilt switch 7, which is near horizontal, will allow the roller ball to remain at the front and lowest part of the tilt switch during minimal acceleration, leaving the circuit open and the alarm inactivated.

During excessive acceleration, the roller ball rolls upwards and back to close part of the electrical circuit.

A vertical rod tilt switch 14 composed of a conductive metallic weight hung by a vertical rod pivoting on a metal axel shaft 13 provides final connection to close the circuit. When the vertical rod tilt switch rotates backward due to increasing acceleration, the metal weight makes contact with a metal pin 11 closing the remainder of the circuit.

The remainder of the closed electrical circuit also contains wires 6, battery 10, visual L.E.D. light 15, and an audible speaker 16 are activated upon the fully closed circuit, instantly alarming the driver of increased acceleration and gasoline consumption. The driver can then instantly reduce acceleration and gasoline consumption.

The invention is claimed as:

1. A acceleration alarm comprising a roller ball tilt switch and L.E.D. light connected to a rotating base to adjust the angle of the roller ball switch to adjust sensitivity to acceleration.
